(19) United States
(12) Patent Application Publication
(10) Pub. No.: US 2008/0223309 A1
(43) Pub. Date: Sep. 18, 2008

(54) SOW CHUTE AND HOIST

(75) Inventor: MAX WINDERS, Belle Plaine, MN (US)

Correspondence Address: MCKEE, VOORHEES & SEASE, P.L.C., 801 GRAND AVENUE, SUITE 3200, DES MOINES, IA, 50309-2721, US

(73) Assignee: ZINPRO CORPORATION, Eden Prairie, MN (US)

(21) Appl. No.: 11/686,183

(22) Filed: Mar. 14, 2007

(51) Int. Cl. A01K 15/04

(52) U.S. Cl. 119/728

(57) ABSTRACT

An immobilizing sow chute to allow hoisting and holding horizontally a sow for foot treatment. The device immobilizes the animal, allows it to be conveniently lifted and allows close work on the animal's feet to provide needed inspection and treatment/therapy without risk of either harm to the animal or the operator by being kicked by the sow.

### FIELD OF THE INVENTION

The invention generally relates to an immobilizing sow chute to allow for hoisting and horizontal holding of a sow for foot treatment, all done in a manner that can be accomplished by a single operator.

### BACKGROUND OF THE INVENTION

Lifting devices for animals are generally known. In the most general sense, they often incorporate a winch having a cable attached thereto and some form of sling lifted by the winch to cradle the animal inside of the sling apparatus. While such lifting devices are generally described and known, there is a need for a very specific lifting device, designed especially for sows to allow for foot inspection and treatment. Such a device presents unique problems. For example, an effective immobilizing sow chute must be ‘sow friendly’. That is to say, the chute must be easy to enter, easy to exit, and causes no harm or alarm to the sow when she is restrained. An effective chute must prevent the sow from fighting, squealing, and kicking while her feet are inspected and/or treated.

Another special problem with sows is they are very heavy and that the hoist must allow hoisting of the animal in a manner that does not risk injury either to the animal's legs, shoulders, hips, or cause other internal injuries. Furthermore, the chute must present the sow in a manner which is safe for persons to inspect/treat the sow's feet. One way of avoiding injuries to the animal is to provide adequate support through the sling, while maintaining the animal in a standing position during lifting. Therefore the weight is equally distributed.

Finally, an effective sling to immobilize sows for foot examination must be one which can be operated by a single operator, because many times no one else is around.

A primary object of the instant invention is to provide a sling which solves each of the above problems and fulfills each of the needs created by these problems; that is to say this sow chute is one in which the animal can be easily driven; one in which the animal can be hoisted without high risk of injury; one in which the animal can be immobilized and held substantially horizontally; and one which can be operated by a single operator.

Another object of the invention is to provide an immobilizing sow chute which fulfills each of the above needs and accomplishes each of the above objectives with a device that is easy to manufacture and simple and effective in operation.

The method and means of accomplishing each of the above objectives as well as others will become apparent from the detailed description of the invention which follows.

### BRIEF SUMMARY OF THE INVENTION

An immobilizing sow chute to allow hoisting and holding horizontally a sow for foot treatment. The device immobilizes the animal, allows it to be conveniently lifted and allows close work on the animal's feet to provide needed inspection and treatment/therapy without risk of either harm to the animal or the operator by being kicked by the sow.

### BRIEF DESCRIPTION OF THE DRAWINGS

FIG. 1 is a perspective view of the immobilizing sow chute of the invention.

FIG. 2 is a view similar to FIG. 1 with the sow in the chute ready to be immobilized.

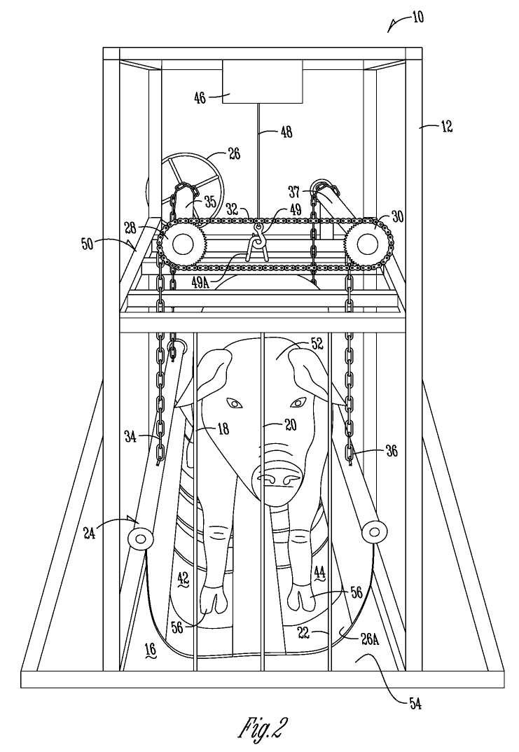

FIG. 3 is a side view of the chute shown in FIGS. 1 and 2 with the sow in lifted position with its feet in position for examination and, if necessary, treatment.

### DETAILED DESCRIPTION OF THE PREFERRED EMBODIMENT

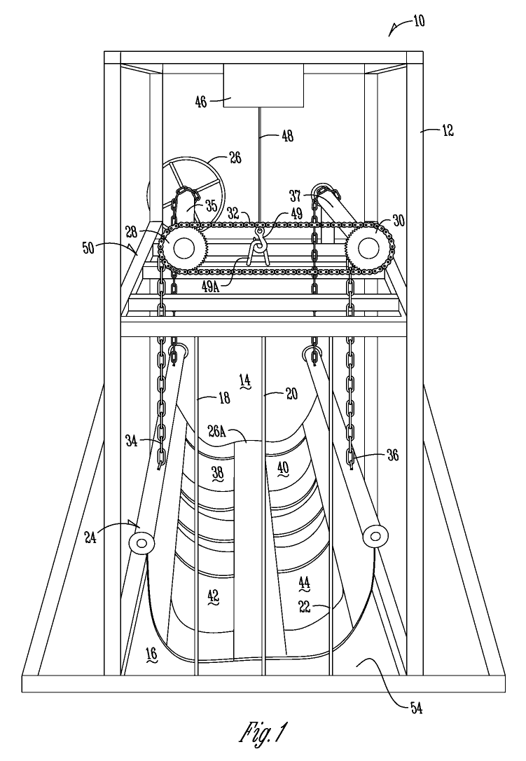

Referring to the drawings and initially to FIG. 1 there is shown an immobilizing sow chute system 10. The system 10 is comprised of a chute frame 12 having a front entrance 14 and a rear end 16 blocked to prevent egress by bars 18, 20 and 22. Mounted within chute frame 12 for vertical raising and lowering is a sling 24. Sling 24 has support straps 26 mounted to allow areas for sow's feet to fit through the sling straps. Sling 24 is attached to a rotatably mounted hand winch mechanism 26 and turning of winch mechanism 26 results in sprocket 28, operably connected to sprocket 30 via endless chain drive 32, to rotate. As a result, rotating the handle of winch mechanism 26 pulls up vertically sling 24 since it is connected to the winch via chain 34 and 36 which rolls up onto rollers 35 and 37, attached to sprockets 28 and 30. Correspondingly hand winch 26 can be rotated the opposite direction to lower the sling 24 down. Thus, when a sow 38 is driven into the chute via entrance 14, hand powered winch 26 can be rolled up to eliminate the slack in the sling and gently bring in into contact with the sow's belly. The animal's four legs stay on the floor for the reason of apertures 38, 40, 42 and 44 in the sling straps 26A. In this manner the animal is gently fitted into the sling and put into position ready for raising. After the slack is taken up, a motor driven winch mechanism 46 mounted on the top of chute frame 12 is operated. The winch mechanism 46 includes at least one cable 48 attached to the chute cage 50. Chute cage 50 is mounted so that it may be raised and lowered within chute frame 12 via operation of motor driven winch 46 and cable 48 connected via hook 49 to draw loop 49A. The cage moves up and down like an elevator, with the sow carried in sling 26.

It goes without saying that while this general description has been given for sows, the system can be used for gilts, boars or other animals as well. In general it has use for any domestic animal of considerable weight that needs to be held suspended upright for foot inspection.

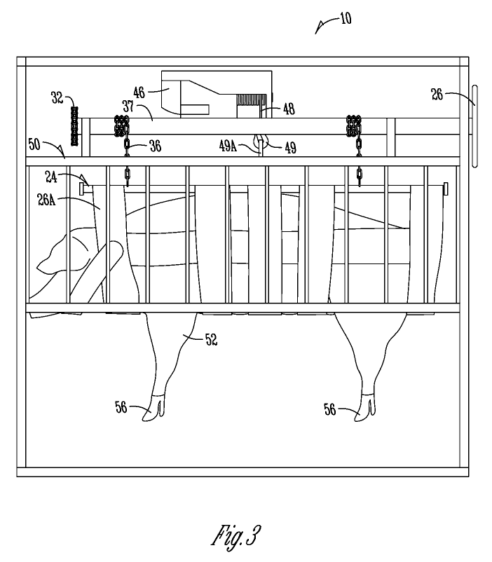

From the above description it can be seen how the immobilizing sow chute can assist an animal handler in lifting a sow in need of foot examination and perhaps treatment. The sow 52 is driven through entrance 14 to stand in the sling 24 which rests on the ground 54. The sow's feet rest on ground 54 inside of the sling 24 through apertures 38, 40, 42 and 44. Thereafter the user or animal handler raises hand powered winch 26 up under the animal's belly by turning handle 26 so that the sling 24 gently moves into proper position of supporting the belly or underside of the sow 52. After the slack is out, motor driven power winch 46 is operated and since it is operably connected to the cage 50, the cage rises vertically in chute frame 12. The animal then is immobilized and suspended in the air above the ground 54, as shown in FIG. 3. Its feet 56 may be closely inspected without danger. Upon lowering back to the ground, the sow 52 again stands on the ground 54 and is prevented from going out the back of the cage by bars 18, 20 and 22, and must therefore back out through the entrance 14 and is then free to go where it wishes.

From the above description it can be seen that the animal can be easily driven into the cage 50, will not go through the cage because of bars 18, 20 and 22 and that it can be easily hoisted and maintained in a horizontal position without significant injury risk. Likewise while immobilized it's feet 56 can be examined and, if necessary, treated and then the animal 52 lowered and egress allowed. Importantly, this can all be accomplished by a single operator.

It therefore can be seen that the invention accomplishes at least all of its stated objectives.

What is claimed is:

1. An immobilizing chute to allow hoisting and holding upright an animal for foot treatment, without danger, comprising:
a chute frame having an entrance end and an exit end;
a sling movably mounted within said frame for raising and lowering a sling;
means for taking up the slack in the sling; and
power means operably connected to said frame for raising and lowering said frame and sling.

2. The immobilizing sow chute of claim 1 wherein said means for taking up sling slack is a hand powdered device to move said sling up under the belly of a sow to take up sling slack before the raise/lower power means is operated.

3. The immobilizing sow chute of claim 2 wherein the sling is configured to allow the animal to stand in the chute with its feet on the floor so that when the sling is raised the feet protrude through the sling in an immobilized manner.

4. The immobilizing sow chute of claim 1 wherein the raising and lowering power means is a motor-driven winch.

5. The immobilizing animal chute of claim 2 wherein the hand powered device is chain driven.

6. The immobilizing animal chute of claim 1 which includes a chute cage movably mounted within the chute frame for vertical raising and lowering, and wherein the sling is movably mounted to the chute cage.

7. A method of raising and lowering sows and other animals for foot inspection comprising:
providing a carrying sling having means for gently raising and lowering to contact with an animal; and
an additional motor driven winch to raise and lower the animal after the gentle raise and lower has occurred.
